(19) United States
(12) Patent Application Publication
(10) Pub. No.: US 2004/0161055 A1
(43) Pub. Date: Aug. 19, 2004

(54) Decision directed carrier recovery using the CORDIC algorithm

(75) Inventor: Amit Sinha, Marlborough, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Engim, Inc., Acton, MA

(21) Appl. No.: 10/731,417

(22) Filed: Dec. 9, 2003

Related U.S. Application Data
(60) Provisional application No. 60/431,907, filed on Dec. 9, 2002.

(51) Int. Cl. H04L 27/14

(52) U.S. Cl. 375/322

(57) ABSTRACT

The invention relates to using a shift-and-add technique with a group of pre-calculated angles, such as the Coordinated Rotation Digital Computer (CORDIC) algorithm, in a hardware efficient digital carrier offset compensation loop. The implementation uses the shift-and-add technique for an efficient arctangent structure calculating phase offset errors. The implementation optionally uses the shift-and-add technique as a Numerically Controlled Oscillator (NCO) to track and compensate for a phase shift.

### RELATED APPLICATION

This application claims the benefit of U.S. Provisional Patent Application No. 60/431,907, filed Dec. 9, 2002. The entire teachings of the above application are incorporated herein by reference.

### BACKGROUND OF THE INVENTION

Carrier recovery and frequency offset compensation are important functions implemented in most digital communication receivers. Information is typically transmitted in a sequence of symbols having a timing relationship generally prescribed by a transmitter's local timing source. The receiver usually has an independent local timing source, or reference oscillator, which is not phase/frequency locked with the transmitter. As a result, the phase of the data bearing signal can drift leading to performance degradation if left uncompensated.

In one example, an ideal Quadrature Phase Shift Keying (QPSK) modulated passband signal at the input of a receiver can be described by equation 1.

$$r ( t ) = {ⅇ}^{( j 2 π {f}_{TX} t + {φ}_{TX} ( t ) )} {\sum }_{n = - ∞}^{∞} {α}_{n} p ( t - nT ) + n ( t ) \qquad ( 1 )$$

The transmit center frequency is represented by f_{TX}, with αₙ representing the transmitted QPSK symbol, and p(t) representing the combined response of the transmit filter, linear distortion in the channel and the receive filter. The phase jitter introduced by the transmitter is represented by φ_{TX}(t), and additive noise in the system, represented by n(t). If the receiver carrier frequency is f_{RX}, and the receiver is sampling at a time instance t=kT, with k representing sample number and T representing sample period (1/T being the sample rate), the received samples can be described by equation 2. Notably, rₖ defines baseband digital complex samples.

$${r}_{k} = {ⅇ}^{( j 2 π Δ fkT + {φ}_{TX}^{k} - {φ}_{RX}^{k} )} {\sum }_{n = - ∞}^{∞} {α}_{n} {p}_{k - n} + {n}_{k} \qquad ( 2 )$$

In equation 2, the term Δf refers to the quantity f_{TX}-f_{RX} representing a frequency offset between a transmitter and the receiver. When the received stream of samples has been passband equalized, such that the Nyquist criteria is satisfied, Pₖ becomes an impulse, and the received samples can be further simplified as described by equation 3. Equation 3 suggests that the received symbols will result in a rotating constellation with phase jitter φₖ and additive noise nₖ. If a coherent detector is used, the receiver will make an error every time a symbol rotates past its decision boundary.

rₖ=e^{(j2πΔfkT+φ}^{ₖ}⁾αₖ+nₖ (3)

The result of frequency offset upon successive received samples is illustrated in FIG. 1. An exemplary I-Q constellation diagram for Binary Phase Shift Keying (BPSK) shows the BPSK symbols: +1 and −1. Vectors r₀, r₁, r₂ and r₃ represent four successive received digital complex samples. In this example, a BPSK +1 symbol was transmitted for each of the corresponding received samples. The first received sample r₀ is received with negligible phase delay. Because of the frequency offset between the receiver and the transmitter, the second received sample r₁ is phase shifted by a value of approximately 2πΔfT. As the second received sample also resides with the shaded region representing a +1 BPSK decision region (i.e., quadrants I and IV), it will correctly be interpreted as a +1 without error. Similarly, the next received sample r₂ is also received with an increased phase delay, but still without error. The next sample, however, is received with an error of 3(2πΔfT) and no longer resides within the +1 decision region. Accordingly, a BPSK receiver would erroneously determine that the symbol transmitted by r₃ was a BPSK −1.

A carrier recovery feedback loop can be used to compensate for the phase drift induced by frequency offset between the transmitter and receiver. In particular, decision-based, carrier recovery schemes include receiving a sample, comparing the received sample to expected symbol values depending on the particular type of modulation, and mapping the received sample to one of the expected symbol values. Decision-directed, carrier recovery, however, suffers from phase ambiguity. For example, if the received sample has a phase delay or error greater than some maximum value (e.g., π/4 for the exemplary QPSK constellation), the measured phase error will be incorrect as it will cross, or “wrap around,” a decision boundary, being erroneously interpreted as the next symbol of the constellation. The problem can be mitigated by using differential encoding. Unfortunately, however, systems using differential encoding generally perform less efficiently. For example, in differential encoded systems, errors tend to propagate into adjacent bits. Thus, for systems operating at low Signal-to-Noise Ratios (SNR), the effect of bit errors will be amplified. Despite these performance disadvantages, prior art systems have used differential encoding to simplify receiver design.

Other prior art solutions are not necessarily limited by type of modulation. For example, some solutions include providing a highly-stable timing reference (e.g., a rubidium clock) that can maintain timing at a receiver accurately with respect to a remote transmitter. Other solutions include using a separate channel to broadcast precise timing information to the receivers. This approach unnecessarily wastes channel bandwidth. Yet other prior art solutions include providing precision Phase Locked Loops (PLL), such as PLLs that operate at Radio Frequency (RF), for example, tracking a receiver's Local Oscillator (LO).

Unfortunately, the problems related to cost and technical complexity of the prior art solutions are amplified in cost-sensitive applications, such as in Wireless Local Area Network (WLAN) applications. WLAN systems generally rely on a limited number of access points, each capable of communicating with a large number of remote users. It is the cost and complexity of the remote users that must be kept to a minimum to ensure public acceptance and profitability.

### SUMMARY OF THE INVENTION

The present invention solves the problems of the prior art solutions by providing a cost-effective and efficient decision-based digital carrier recovery, using a class of shift and add algorithms. These algorithms are implemented in a hardware efficient manner, that is particularly well suited to Very Large Scale Integration (VLSI) applications. Advantageously, the present invention can be implemented using only adders and shifters, thereby avoiding the cost and technical complexity associated with multipliers. Apart from being hardware efficient, the architecture allows tradeoffs between computation accuracy and loop stability.

The invention relates to phase processing of in-phase and quadrature phase (I & Q) signals. The phase processing includes receiving successive digital I & Q complex samples, such as baseband outputs from a complex Analog-to-Digital Converter (ADC) within a receiver. A corresponding phase offset estimate is stored in a phase offset register and provided for each of the successive digital I & Q complex samples. For each sample, the phase processing also includes phase compensating circuitry compensating for any phase drift by iteratively scaling, manipulating, updating the (i) I & Q complex samples, and (ii) the corresponding phase estimate, to converge to a compensated sample value.

In some embodiments, the phase compensating circuitry includes a number of registers for storing complex samples and angles. For example, in one embodiment, a first register temporarily stores an in-phase component of each of the digital complex samples and a second register temporarily stores a corresponding quadrature component of each of the digital complex samples. A first adder receives an input from each of the first and second registers and provides an output to the first register. Similarly, a second adder receives an input from each of the first and second registers and provides an output to the second register. A third register temporarily stores a corresponding phase estimate. A memory unit stores a number of pre-computed angles, and a third adder receives inputs from each of the third register and the memory unit providing an output to the third register. Each of the adders is capable of selectively adding or subtracting its respective input values. Accordingly, the phase compensating circuitry iteratively scales, manipulates, and updates each sample using the stored number of pre-computed angles. Advantageously, the phase estimation circuitry can have the same general form as the phase compensating circuitry.

The number of pre-computed angles described above, e.g., φₙ, can be defined by φₙ=arctangent (½ⁿ). The value n represents an integer variable having unique value corresponding to each of the number of pre-computed angles (e.g., n=0, 1, 2, 3, 4). The iterative scaling, manipulating, and updating can also include shifting and adding both the in I & Q complex samples and the corresponding phase estimate. In some embodiments, the shift operations use barrel shifters.

Generally, the corresponding phase offset estimate is updated, or revised for each sample. Updating the phase offset estimate can include determining a compensated sample angle. This angle is associated with the compensated sample value. Similarly, updating the phase offset estimate can include determining an expected symbol angle associated with an expected symbol value. The expected symbol angle can be determined, for example, using a slicer. The expected symbol angle can be a stored value, a hard-coded value, and/or a look-up table of multiple values. The phase offset estimate is next determined by calculating a difference angle between the compensated sample angle and the expected symbol angle.

In some embodiments, the compensated sample angle is determined by initially providing an estimate of the compensated sample angle. Then the compensated sample value and the compensated sample angle estimate can be iteratively scaled, manipulated, and updated to converge to a compensated sample angle. The iterative scaling, manipulating, and updating can also use a number of pre-computed angles, similar to those described above in reference to determining the phase offset estimate.

The phase offset estimate is then updated by combining it with the determined difference angle, which may optionally be filtered to smooth out fluctuations due to phase noise or spurious effects that are generally random and short-lived. The filter can include digital filter, such as a Finite Impulse Response (FIR) filter, an averaging filter, and/or a gain stage for adjusting a gain of the determined difference angle.

To obtain additional efficiencies, the compensated sample value is initially converted into a corresponding value residing in a first quadrant of an I-Q constellation. For example, if the compensated sample resides in the second or third quadrants, an initial π radians (i.e., 180°) can be added to or subtracted from the argument of the complex compensated sample, thereby effectively rotating the compensated sample to the first or fourth quadrant. Alternatively, the signs of the corresponding in-phase and quadrature sample components can be inverted, if initially negative, such that both components will be positive, thus placing the manipulated compensated sample into the first quadrant.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic I-Q diagram illustrating an increasing phase drift for successive received samples in a system using BPSK modulation;

FIG. 2 is a block diagram of a decision-directed carrier recovery solution;

FIG. 3 is a schematic I-Q diagram illustrating a phase drift of a received sample in a system using QPSK modulation;

FIG. 4 is a block diagram of one embodiment of the invention used in a wireless RF application;

FIG. 5 is a block diagram of one embodiment of a shift-and-add based architecture configured for decision-based carrier recovery;

FIG. 6 is a block diagram of one embodiment of a CORDIC engine;

FIG. 7 is a schematic I-Q diagram of the angle rotations implemented according to the CORDIC engine of FIG. 6;

FIGS. 8A and 8B are schematic diagrams illustrating angle computation and rotation;

FIG. 9 is a graph illustrating CORDIC angle estimation error; and

FIGS. 10A-C are flow diagrams illustrating one embodiment of a process implementing decision-based carrier recovery.

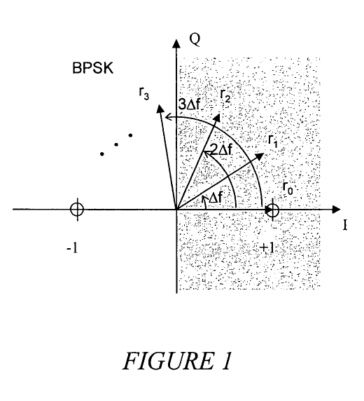

### DETAILED DESCRIPTION OF THE INVENTION

A description of preferred embodiments of the invention follows.

The present invention solves the problems of the prior art solutions by providing a cost-effective and efficient decision-based digital carrier recovery, using a class of shift and add algorithms, such as the CORDIC algorithm. In brief overview, a phase offset is determined using the received digital complex samples themselves, rather than packet or frame preambles and/or pilot tones. The phase offset can then be applied to subsequent received digital complex samples to de-rotate them, effectively removing phase error. As the phase-corrected samples are typically still not perfect due to additional phase drift since the last update of the phase offset, a residual phase value can be determined and used to update the phase offset for subsequent samples. The process can continue in this manner, continually updating and applying the phase offset estimate with each received sample.

Advantageously, the present invention can be implemented as a CORDIC algorithm using only adders and shifters, thereby avoiding the cost and technical complexity associated with multipliers. In operation, the received sample value and the phase offset estimate are input into a first CORDIC engine. This engine rotates the received sample by an angle related to the phase offset estimate, thereby correcting the phase offset of the received sample. A second CORDIC engine is used to determine the angle of the resulting corrected sample vector. The second CORDIC engine rotates the received corrected sample vector to the X axis and determines the magnitude of the angle required for this rotation. That angle is subtracted from an expected symbol angle yielding a difference angle indicative of any phase offset due to additional phase delay. Any additional phase offset is preferably combined with the accumulated phase delay estimate in an accumulator.

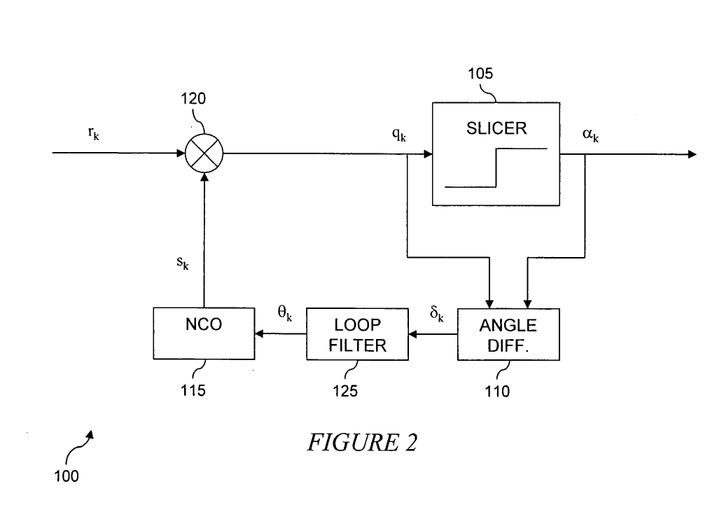

A decision-based, frequency-offset compensation loop is illustrated in FIG. 2 that tracks the phase drift and compensates for it. The frequency offset compensation loop 100 includes a decision element 105, or slicer, a drift detector 110, a loop filter 125, a Numerically Controlled Oscillator (NCO) 115, and a mixer 120. The loop 100 receives a digital complex sample rₖ and combines it in the mixer 120 with the output Sₖ of the NCO 115. The output of the mixer 120 is a phase-compensated sample qₖ. The output of the NCO 115 represents an estimate of the phase offset or phase drift of the received sample. The mixer 120 multiplies the two inputs resulting in a de-rotation of the received sample by the phase offset estimate. The slicer 105 receives the phase-compensated sample qₖ and maps it to a corresponding symbol value αₖ. In a digital communications system, a slicer 105 is used to decide, or slice, a particular symbol value associated with an input sample. In this manner, the slicer can be though of as a symbol regenerator as it maps the value of the input sample to one of a predetermined number of symbol values.

The phase drift detector 110 measures the angle drift between the input and output of the slicer 105 or decision device. In the absence of phase jitter and noise, the phase of successive receives samples will drift from the ideal constellation points by an amount δₖ=2πΔfT. The drift detector 110 measures this drift, or residual phase offset δₖ, as a difference between the phase-compensated sample value and the corresponding symbol value. Typically, the residual phase offset is smoothed by a loop filter 125 to remove phase jitter and noise. The NCO 115 then uses the updated phase estimate to correct subsequent received digital samples rₖ₊₁ in a similar manner.

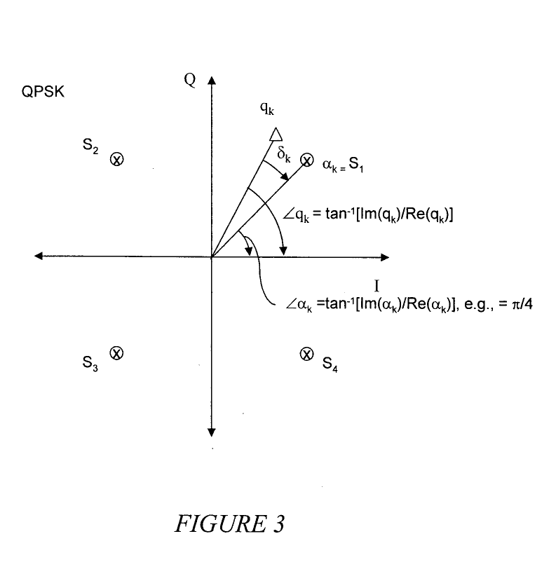

An example of a phase drift calculation is illustrated in FIG. 3 for a QPSK modulated signal. The expected QPSK symbol values are identified by S₁ through S₄. An exemplary received phase-compensated sample qₖ resides in the first quadrant with an associated angle ∠qₖ. A slicer 105 would likely conclude that qₖ maps to αₖ=S₁. Thus, the residual phase offset is computed as the difference between ∠qₖ and ∠αₖ.

Several approximation techniques exist to estimate this phase drift. An accurate method for measuring the phase difference involves calculating an angle by taking the arctangent of a ratio of the real and imaginary parts of the received complex vector.

$${δ}_{k} = {tan}^{- 1} ( \frac{Im ( {α}_{k} )}{Re ( {α}_{k} )} ) - {tan}^{- 1} ( \frac{Im ( {q}_{k} )}{Re ( {q}_{k} )} ) \qquad ( 4 )$$

Once the phase drift is estimated, it can be filtered to reduce the effect of phase jitter and noise. The filtered phase drift estimate θₖ can then be input into the NCO 115, which accumulates θₖ (modulo 2π) and drives a sine/cosine generator computing the complex quantity e^{jΣθ}ₖ. It is this complex quantity that is used to de-rotate incoming samples. For example, the output of the NCO 115 can be e^{jΣθ}ₖ, which de-rotates a received sample at the mixer 120 by adding the accumulated phase drift estimate θₖ from the sample, thereby compensating in a phase direction opposite to the phase drift.

The CORDIC algorithm belongs to a class of shift-add algorithms that efficiently rotate vectors. The algorithm performs a vector rotation using a series of pre-computed angles, which can be implemented using shift and add operations. The original work on CORDIC algorithm is credited to Volder. The algorithm, is well adapted to hardware implementations, and has found its way into microprocessors, calculators, and digital signal processors.

Generally, a 2×2 matrix, such as the one described in equation 5, can rotate a vector (x,y) by an angle φ. Advantageously, the rotation can be limited to a predetermined number of angles.

$$[ \begin{matrix}{x}^{′} \\ {y}^{′}\end{matrix} ] = [ \begin{matrix}cos φ & - sin φ \\ sin φ & cos φ\end{matrix} ] [ \begin{matrix}x \\ y\end{matrix} ] \qquad ( 5 )$$

For example, the limited angles can be related to powers of 2, described by φₙ=tan⁻¹(2⁻ⁿ). Table 1 lists exemplary angles using powers of 2.

TABLE 1
Exemplary Predetermined Angles, φ

| n | 2⁻ⁿ | φₙ = tan⁻¹ (2⁻ⁿ). |
|---|---|---|
| 0 | 1 | 45.0° |
| 1 | 1/2 | 26.5° |
| 2 | 1/4 | 14.0° |
| 3 | 1/8 | 7.1° |
| 4 | 1/16 | 3.6° |
| 5 | 1/32 | 1.8° |
| 6 | 1/64 | 0.9° |
| 7 | 1/128 | 0.4° |

Substituting these limited angles into equation 5, and rearranging, yields an iterative algorithm described in equation (6).

$$\begin{matrix}{x}_{n + 1} = {G}_{n} ( {x}_{n} - {y}_{n} {d}_{n} {2}^{- n} ) \\ {y}_{n + 1} = {G}_{n} ( {y}_{n} + {x}_{n} {d}_{n} {2}^{- n} ) \\ {z}_{n + 1} = {z}_{n} - {d}_{n} {tan}^{- 1} ( {2}^{- n} ) \\ {G}_{n} = cos ( {tan}^{- 1} ( {2}^{- n} ) ) = \frac{1}{\sqrt{1 + {2}^{- 2 n}}} \\ {d}_{n} = \pm 1\end{matrix} \qquad ( 6 )$$

Thus, successive vectors are computed by rotating an initial vector (x₀, y₀) through the predetermined number of angles (±φₙ). A value of dₙ determines the direction of the rotation applied to each rotation angle. Notably, the particular values of dₙ, are not determined beforehand, but are determined during the vector rotation process as described below in more detail. The total angular rotation is accumulated in zₙ. The final vector outputs have amplitude gain equal to ΠGₙ, which converges to 0.6073 as n→∞. If the scale factors are removed from successive iterations the final vector has a gain of 1/0.6073=1.6466.

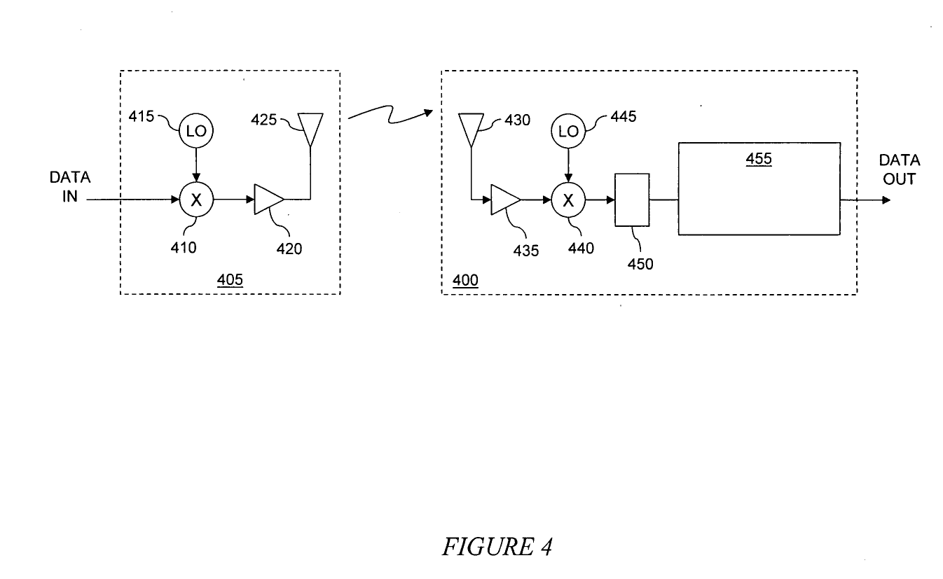

In some embodiments, decision-based carrier recovery is implemented in a communications receiver, such as the wireless receiver shown in FIG. 4. A wireless receiver 400 receives an RF signal from a remote transmitter 150. The transmitter 450 receives data and up converts the data to an RF signal using a mixer 410 and a transmit local oscillator 415. The up-converted signal may be amplified in a gain stage 420 before being transmitted from a transmit antenna 425. The receiver 400 receives the transmitted RF signal at a receive antenna 430. The receiver 400 typically amplifies and/or filters the received signal using a signal conditioning stage 435, then down converts the conditioned signal to baseband using a mixer 440 and a receiver local oscillator 445. The baseband received signal is next converted into a digital signal using an analog-to-digital conversion stage 450, that itself may apply further signal conditioning. The digital output samples are then phase-compensated at baseband in a processing block 455 using a decision-based, carrier-recovery technique described in more detail below.

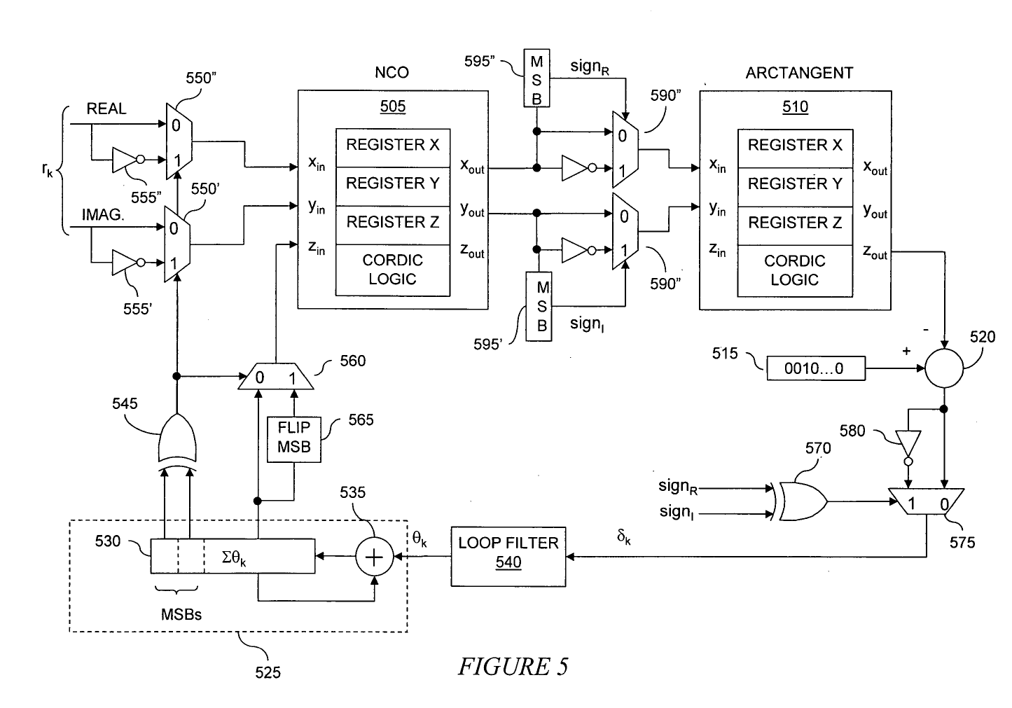

Referring again to FIG. 2, at least two general operations are required to implement a carrier recovery loop: (i) an arctangent-based phase drift computation, and (ii) a vector-rotation in the opposite sense to compensate for the drift. At least one architecture for a decision-based, carrier-recovery processing block 455 using the shift and add algorithms is shown in FIG. 5. The carrier recovery element 455 receives a digital complex sample rₖ (e.g., having associated I and Q values, i.e., real and imaginary values). The received sample can be represented as a vector xᵢₙ, yᵢₙ and is input into a first vector rotation engine 505 together with a phase offset estimate Σθₖ (i.e., zᵢₙ). The first vector rotation engine 505 rotates the input vector by the phase offset estimate initially stored in zᵢₙ. The result is an output vector xₒᵤₜ, yₒᵤₜ that corresponds to a phase-compensated sample value qₖ.

A second vector rotation engine 510 receives at its inputs xᵢₙ, yᵢₙ the real and imaginary values of the phase-compensated sample qₖ described above. The second vector rotation engine 510 determines the angle of qₖ (∠qₖ), by rotating the received input vector to a zero angle (e.g., rotating it onto the X axis). The angle can be determined as the value of the resulting rotation. Thus, the second vector rotation angle can be thought of as performing an arctangent function (i.e., it determines an angle defined by a complex input quantity xᵢₙ, yᵢₙ).

The angle of the phase-compensate sample is then compared with an angle of an expected received symbol (e.g., ∠αₖ). For example, the value ∠αₖ can be stored in a register 515, hard-wired, or for more complex modulation techniques, stored in a look-up table. An angle difference element, or subtractor 520, receives ∠qₖ and ∠αₖ and provides a corresponding output value δₖ, indicative of the difference between the two received angular values.

An accumulator 525 receives the difference angle and updates an accumulated phase offset estimate using the received difference angle. In one embodiment, the accumulator includes a register 530 storing the accumulated phase offset estimate and an adder 535. The adder 535 receives the accumulated phase offset value from the register 530 and the difference angle, adds the two values and forwards the resulting combination to the register 530, which stores the combined value as an updated phase offset estimate. The updated phase offset estimate is forwarded to the first vector rotation engine 505 and represents the phase offset estimate for the next sample received (e.g., sample rₖ₊₁).

In some embodiments, a loop filter 540 is coupled between the angle difference subtractor 520 and the accumulator 525. The loop filter 540 filters, or smoothes the difference angle to remove phase jitter and noise. Phase noise is random phase modulation which is typically present in oscillators, such as quartz crystal oscillators. The loop filter can be an averaging filter, or a low-pass filter, for example, implemented as a Finite Impulse Response (FIR) digital filter. In some embodiments, a simple phase tracking loop can also be made using just a gain scaling stage instead of the loop filter. Higher order filters can be used to perfectly track frequency offset and phase jitter at a nominal frequency.

In some embodiments, the two vector rotation engines 505, 510 described above are implemented as two CORDIC engines. The CORDIC engines perform the shift and add algorithm using a limited number of pre-calculated angles, thus eliminating the need to evaluate an arctangent and generally eliminating the need for performing multiplications altogether. The embodiments described herein are directed to QPSK modulation, but can easily be extended to other modulation schemes, such as Binary Phase Shift Keying (BPSK) and higher-order modulation schemes, such as Quadrature Amplitude Modulation (QAM) (e.g., 16, 32, and 64 QAM).

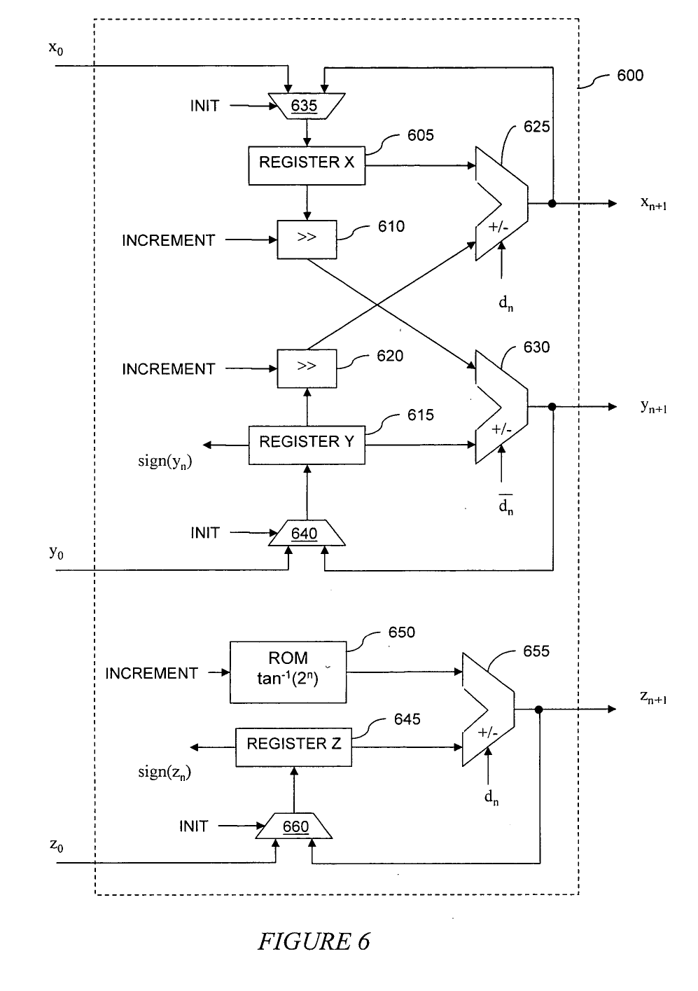

The separate CORDIC engines 505, 510 implementing the NCO and arctangent functions and illustrated in FIG. 5 can be configured using identical hardware. For example, one embodiment of a basic CORDIC engine is illustrated in FIG. 6 that implements equation (6) using accumulators and barrel shifters.

The CORDIC engine 600 includes a first register 605 storing a value of x. A first arithmetic shifter 610 is also provided for operating on the stored value of x, determining a shifted value of x. More specifically, the first shifter 610 could be implemented as a barrel shifter that performs a shift to the right, resulting in division by 2 for binary values—each shift dropping a respective Least Significant Bit (LSB) and adding bits to the left, as required, to preserve the sign (e.g., 1's or 2's complement). Similarly, a second register 615 stores a value of y and a second shifter 620 operating on the stored value of y, determining a shifted value of y. This second shifter 620 can also be implemented as a barrel shift register performing a right shift representing division by 2. A first adder 625 receives the stored value of x and the stored, shifted value of y, combining these values and providing the combination as an output indicative of an updated value of x (i.e., xₙ₊₁). A second adder 630 similarly receives the stored value of y and the, shifted value of x, combining those values and providing the combination as an output indicative of an updated value of y (i.e., yₙ₊₁).

The first adder 625 receives a control input d, (e.g., a binary 0 or 1) that determines whether the adder 625 adds or subtracts its input values. Determination of the value of the dₙ control input is described below in more detail. Similarly, the second adder 630 also receives an inverted control input \overline{dₙ}, such that if the first adder 625 is adding its respective inputs, the second adder 630 is subtracting its respective inputs. The first register 605 is updated with the output of the first adder 625. Thus, the first register 605 contains a refined value of x, as successive additions are performed in an iterative manner. Similarly, the second register 615 is updated with the output of the second adder 630.

The CORDIC engine 600 includes a third register 645 storing a value of z. A storage element 650 stores a number of pre-calculated angles (e.g., the φₙ values described above). The storage element 650 can be a memory unit, such as a Read Only Memory (ROM), or Random Access Memory (RAM). A third adder 655 receives the stored value of z and one of the pre-calculated angles from the storage element 650. The third adder 655 combines these values and provides the combination as an output indicative of an updated value of z (i.e., zₙ₊₁). The third adder 655 receives a control input dₙ (e.g., a binary 0 or 1) that determines whether the adder adds or subtracts its respective input values.

Each of the registers 605, 615, and 645 includes respective circuitry for initializing the register to a predetermined value. For example, a first multiplexer 635 determines whether the input to the first register 605 is the output of the first adder 625, as described above, or whether it is an initialization value (e.g., x₀) from another source. Likewise, a second multiplexer 640 determines whether the input to the second register 615 is the output of the second adder 630, or whether it is an initialization value (e.g., y₀) from another source. A third multiplexer 660 determines whether the input to the third register 645 is the output of the second adder 630, or whether it is an initialization value (e.g., y₀) from another source.

Nevertheless, despite having same hardware configuration, the NCO and arctangent CORDIC engines 505, 510 are programmed and controlled differently. For example, to compute the arctangent angle, equation (6) is initialized with the coordinates (x₀,y₀) corresponding to a compensated received sample and z₀ is set to 0, corresponding to the X axis of the I-Q constellation. For successive iterations, dₙ=−sign(yₙ), where the function sign(t) is equal to +1, 0, −1, depending respectively upon whether t>0, t=0, or t<0. Thus, the CORDIC engine rotates the vector (x₀,y₀) onto the X axis (y_{∞}=0) and accumulates the angle zᵢ required in the process, z_{∞}=tan⁻¹(y₀/x₀).

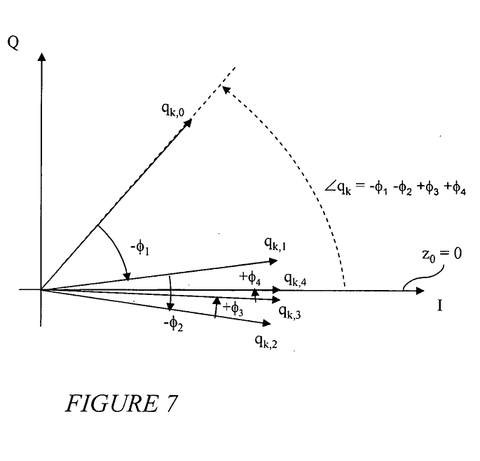

Exemplary results for an arctangent computation are illustrated in FIG. 7. An initial compensated received sample q_{k,0} is mapped into the first quadrant of the an I-Q constellation. The vector q_{k,0} has an associated angle ∠qₖ that is initially unknown. A CORDIC engine using a predetermined number of angles, similar to those described above in Table 1, is loaded with the vector q_{k,0} and the angle z₀=0. As the sign of y₀ is positive (1^{st} quadrant), the first angle φ₁ (i.e., 45°) will be subtracted from the vector, forming a new interim vector q_{k,1}. As the sign of y₁ is still positive (q_{k,1} is still in the 1^{st} quadrant), the second angle φ₂ (i.e., 26.5°) will also be subtracted from the vector, forming a new interim vector q_{k,2}. This time, the sign of yᵢ is negative (q_{k,2} is in the 4^{th} quadrant), so the third angle φ₃ (i.e., 14°) will be added to the vector, forming a new interim vector q_{k,3}. The process continues for a desired number of iterations until the resulting vector is approximately zero. Then, the resulting angle is determined by summing the individual rotation angles. For this example, ∠qₖ=φ₁+φ₂−φ₃−φ₄.

For NCO implementations, x₀ and y₀ are initialized with the input vector corresponding to the uncompensated received sample that has to be rotated (i.e., phase compensated). The value of z₀ is initialized with the desired rotation angle. For successive iterations of the NCO implementation, dₙ=sign(zₙ). The CORDIC engine rotates the vector until the accumulated angle becomes sufficiently close to 0.

In practice, the CORDIC engine is iterated a finite number or cycles. Let us assume that the CORDIC engines are iterated L times for each computation. The arctangent read only memories (ROMs) inside the CORDIC engines have L entries and the corresponding angle resolution error is bounded by tan₋₁(½^{L-1}).

Operation of the CORDIC engines 600 can be controlled using software executed on a control processor, and/or control logic. For example, a state machine can be used to control the initialization and increment calculations. Upon receiving a new sample, the state machine provides an initialization control prompting the CORDIC registers 605, 615, 645 to initialize with appropriate values as described above. Then, the state machine can control the CORDIC engine 600 to iterate, until a final result is obtained. As the CORDIC engine 600 may be operated at a faster clock rate than the sample rate, a clock multiplier may be used. The clock multiplier, not shown, multiplies the sample-rate clock by a value corresponding to “L,” the number of iterations per received sample.

The CORDIC structure is generally limited to angle rotations within certain regions. For example, an NCO CORDIC structure limits angle rotations between −π/2 and π/2 radians (i.e., in the 1^{st} and 4^{th} quadrants). Referring again to FIG. 5, combinational logic, such as an exclusive OR (XOR) gate 545 provides an output depending upon whether the angle resides in the 2^{nd} and 3^{rd} quadrants, as determined by the Most Significant Bits (MSBS) of the accumulated angle. Implementation is simplified if angles are represented as equally spaced points (e.g., 2^{L} points) on a normalized scale corresponding to angles from 0 to 2π. With this representation, the first two most significant bits (MSB) indicate which quadrant the angle resides in. Thus, the relationship between the two MSB and the quadrant can be described, as in Table 2.

TABLE 2
Quadrant versus MSB

| MSB | Quadrant |
|---|---|
| 00 | 1^{st} |
| 01 | 2^{nd} |
| 10 | 3^{rd} |
| 11 | 4^{th} |

Thus, the XOR 545 provides an output of 1 when both inputs are different indicating the value resides in the 2^{nd} or 3^{nd} quadrants. Adding π radians can be accomplished by inverting the signs of both the I and Q components of the input sample. Accordingly, the output of the XOR 545 gate controls multiplexers 550′, 550″ selecting between a 0 input and a 1 input. Each of the 1 inputs represents an inverted value by a respective inverter 555′, 555″. Thus, simply inverting the two binary numbers adds π radians to the input sample. Thus, the sample input into the CORDIC engine is appropriately placed in the 1^{st} or 4^{th} quadrants. Notably, when the sample is rotated by π radians, the sign of the accumulated angle is also “flipped.” For example, a multiplexer 560 can be placed between the accumulator 525 and the first CORDIC engine 505. This multiplexer 560 is also controlled by the output of the XOR 545, providing the accumulated angle when the 0 input is selected and providing a sign inverted accumulated angle when the 1 input is selected. The sign inversion can be accomplished by flipping the MSB of the accumulated angle.

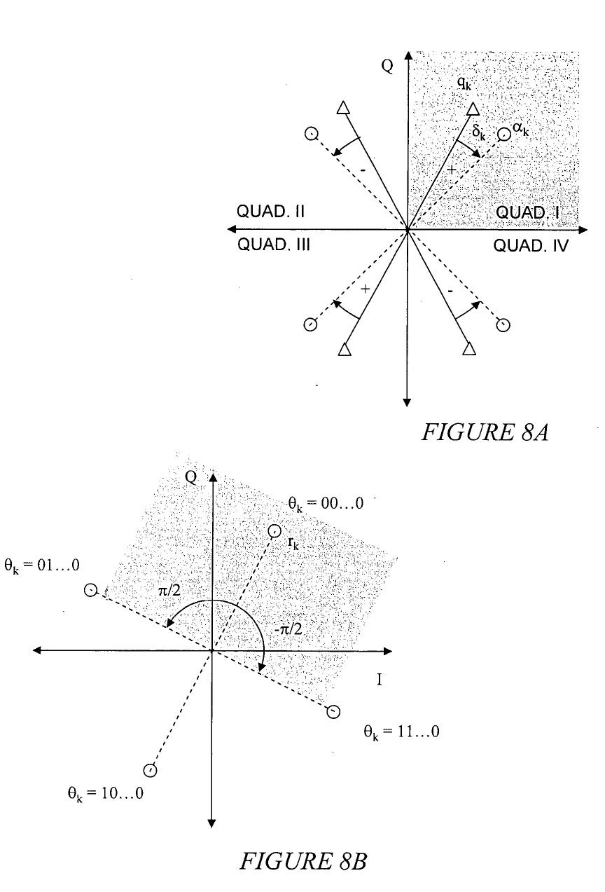

Similarly, the arctangent computation is also generally limited to angles residing within a particular angular region. For example, the arctangent can be limited to angles residing within the 1^{st} quadrant, as shown in FIG. 8A. Having samples in 2's complement representation allows for the sign bit (i.e., the MSB) to be used to determine whether a value is positive or negative. To ensure that the inputs to the arctangent CORDIC engine 510 reside in the 1^{st} quadrant, the MSB of each of the I and Q inputs is used to determine if the respective values are negative. If the respective sign bits are 1, indicating a negative value, then all the bits of that respective input can be inverted (i.e., a 1's complement) to convert that value into a positive value. The resulting positive value is then loaded into the CORDIC engine 510. As a result, the I and Q inputs to the second CORDIC engine 510 will always be positive, resulting in the angle of the vector always being computed in the 1^{st} quadrant, between 0 and π/2. Referring to FIG. 5, independent multiplexers 590′, 590″ (generally 590) can be used, one for each of the I & Q inputs, used to select either the original input, or the inverted input. The value of the MSB of each of the I & Q inputs controls the respective multiplexer 590.

The phase difference, based on equation (4) is computed by subtracting the arctangent angle (in quadrant I) from the expected symbol value, i.e., π/4 for a QPSK system (corresponding to 0010 . . . 0 on a normalized scale). For higher order modulation schemes, a lookup table can be used to reference the angle corresponding to the slicer output. As shown in FIG. 8A, for quadrants I and III, the computed difference has the correct sign. However, the sign of the angle difference is reversed for quadrants II and IV. The sign information of the inputs to the arctangent CORDIC are therefore also used to determine the sign of the angle difference. If the sign bits of the x and y inputs to the arctangent CORDIC are different (corresponding to quadrants II and IV), the computed angle difference is inverted (1's complement). Combinational logic, such as an exclusive OR (XOR) gate 570 can be used. The inputs to the XOR gate 570 are the same sign bits of the I and Q components of the phase-corrected sample described above. The XOR gate 570 provides an output of 1 when the sign bits of the I and Q values are different, indicating that the sample is within the 2^{nd} or 4^{th} quadrants. The output of the XOR gate 570 can be used to control a two-input multiplexer 575 having the difference angle at one input and the inverted difference at another input. The inverted difference angle can be obtained by inverting the difference angle using an inverter 580. Thus, the output of the multiplexer 575 will have the proper sign depending on the initial angle of the phase compensated sample.

The angle difference can then be passed through a loop filter 540. In its simplest form, the loop filter 540 could be a straightforward gain stage. The filtered phase drift is accumulated (modulo 2π). Modulo 2π phase is easily handled by phase accumulators that ignore their overflow bit. This accumulated phase drives the NCO CORDIC engine 505. Since the CORDIC engine is limited to rotations within [−π/2, π/2], an initial rotation of π is performed, if required. This involves a simple sign inversion (using 1's complement arithmetic). The 2 most significant bits of the accumulated phase θₖ determines whether the angle magnitude is greater than π/2, as shown in FIG. 8B. If the two most significant bits are different from each other (01 or 10), the rotation angle corresponds to [π/2, 3π/2]. In this case, the vector is initially rotated by an angle π, and the initial angle loaded into the CORDIC engine is θₖ−π. On a normalized scale, this corresponds to flipping the sign bit of θₖ.

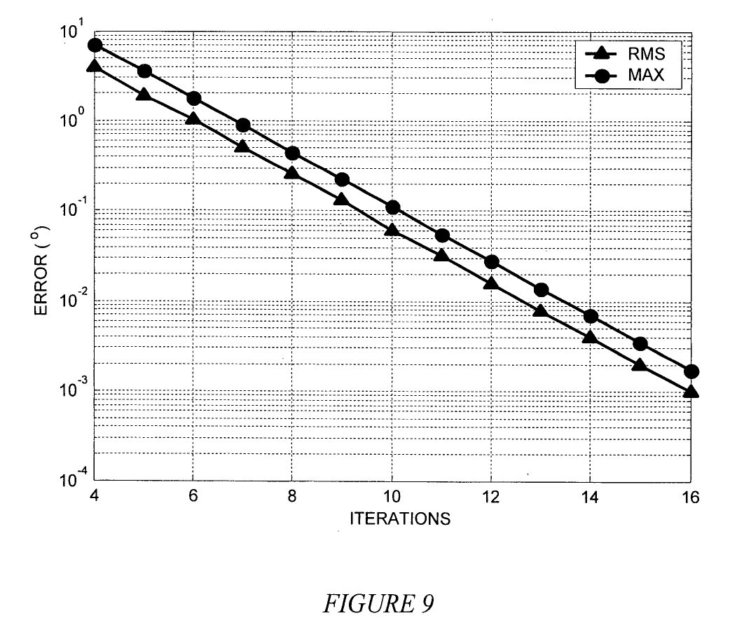

The architecture shown in FIG. 5 has a minimum latency of one cycle through the feedback loop. To realize this latency, the CORDIC engines are clocked faster than the input sample rate. For example, the CORDIC engine can be clocked L times faster than the input sample rate. When a new sample arrives, the NCO rotates the vector, while the arctangent CORDIC is computing the phase drift based on the previous sample. If the input sample rate is high, however, clocking the CORDICs L times faster might not be feasible. In this case, the CORDIC can be implemented in an unwrapped, or pipelined manner. However, every pipeline stage adds latency within the number of iterations. For greater than seven iterations (i.e., L>7), the maximum angle error is less than 1 degree. The choice of the number of iterations can be selected and generally depends on the signal to noise ratio, frequency tracking range and phase noise in the carrier. Error performance of an exemplary CORDIC engine is illustrated in the log-linear graph of FIG. 9. The error performance graph plots the error in degrees versus number of iterations. Two curves are plotted: one representing a root-mean-square (RMS) error, and one representing a maximum error. Both curves decrease with increased number of iterations. Thus, a desired error performance can be attained by implementing a selectable minimum number of iterations using the graph.

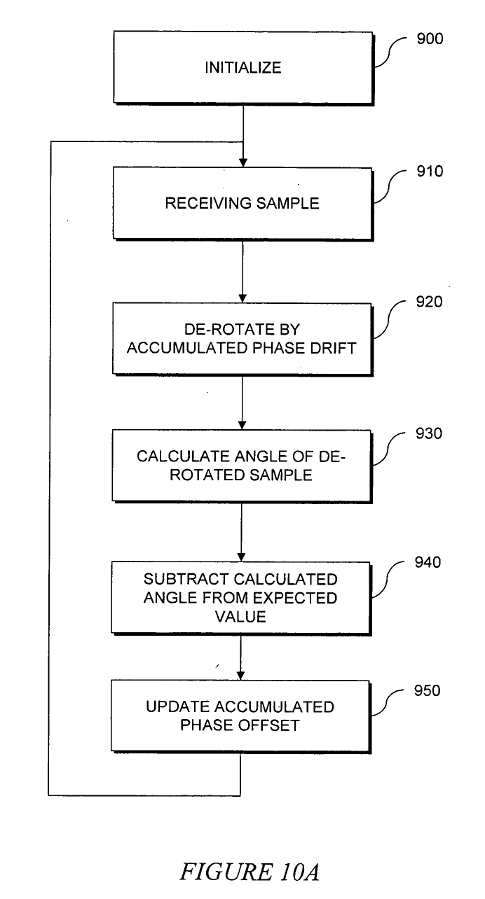

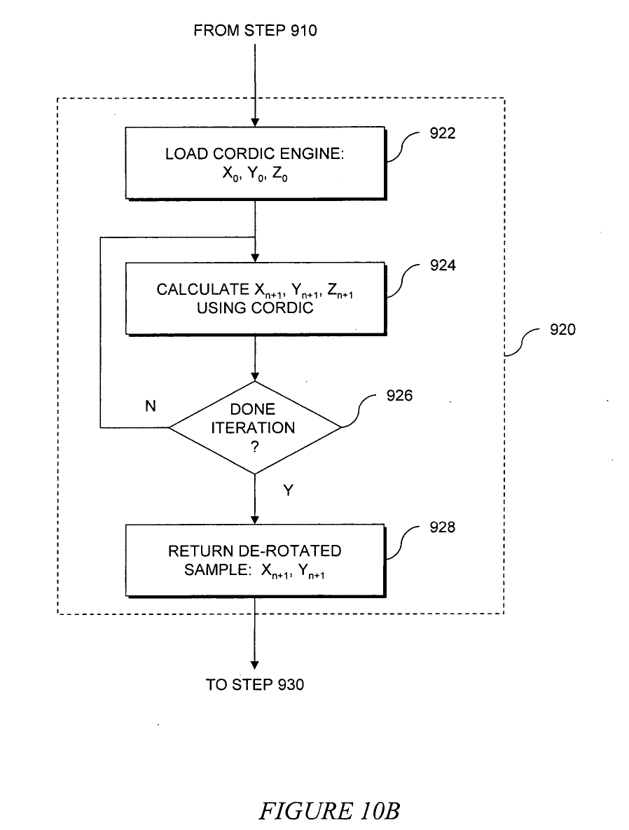

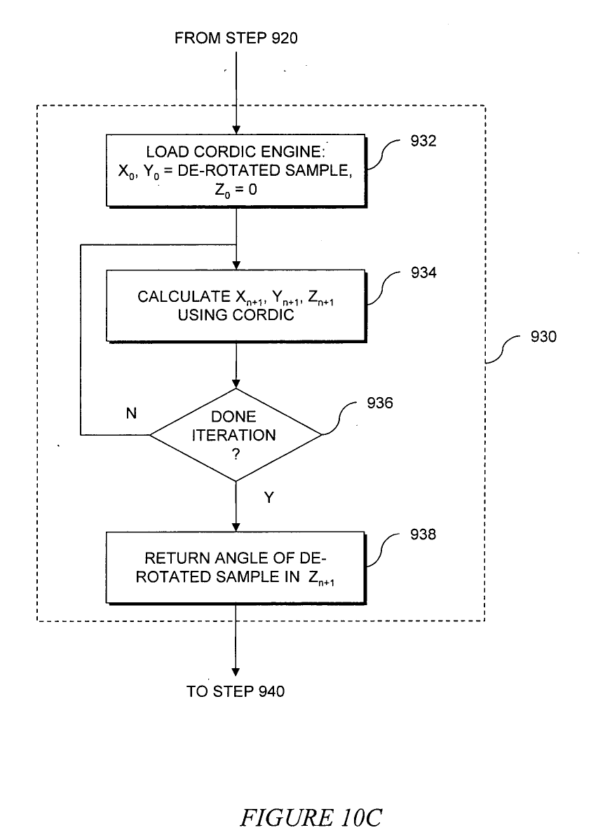

A flow diagram of an embodiment of the invention is illustrated in FIGS. 10A-C. In operation, a decision-based carrier-recovery system is initialized 900. Initialization can include resetting the accumulator storing the accumulated phase offset estimate and/or loading initial values into the registers of the CORDIC engines. The system then receives a digital complex I and Q sample 910. The sample is received with a phase offset related to phase drift between the local timing references of the receiver and remote transmitter. The sample is then de-rotated by the accumulated phase offset 920 resulting in a phase-corrected sample. The angle of the phase-corrected sample is calculated 930 and a difference is determined between the sample angle and an expected value 940. Any difference is generally related to an additional phase drift since the last update of the accumulated phase offset. To preserve system accuracy, the accumulated phase offset is updated or corrected based on the residual phase drift 950. The process repeats for subsequent samples using the most recent value of the phase offset. Periodically, the system can be re-initialized, such as during a phase alignment procedure performed during a preamble of a received data packet.

In more detail, de-rotating by the accumulated phase drift 920 includes loading a first CORDIC engine performing an NCO function with initial values x₀, y₀, z₀ 922. The CORDIC engine updates the stored values, generating the values xₙ₊₁, yₙ₊₁, zₙ₊₁ 924. This step is repeated a number of times. When the iteration has completed 926, e.g., when the step has been repeated a predetermined number of times, the de-rotated sample is returned 928, or output from the CORDIC engine.

Similarly, a second CORDIC engine performing an arctangent function is loaded with the de-rotated sample calculated at 920, and an initial angle of 0. The second CORDIC engine updates the stored values, generating the values xₙ₊₁, yₙ₊₁, zₙ₊₁ 934. This step is also repeated a number of times. When the iteration has completed 936, e.g., when the step has been repeated a predetermined number of times, the resulting angle value is output from the CORDIC engine 938.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of phase processing in-phase and quadrature signals comprising:
receiving successive digital in-phase and quadrature complex samples;
providing a corresponding phase offset estimate for each of the successive digital in phase and quadrature complex samples;
for each sample, compensating for phase drift by iteratively scaling, manipulating, updating the in-phase and quadrature complex samples and the corresponding phase estimate to converge to a compensated sample value.

2. The method of claim 1, wherein iteratively scaling, manipulating, and updating uses a plurality of pre-computed angles.

3. The method of claim 2, wherein the plurality of pre-computed angles φₙ, are defined by φₙ=arctangent (½ⁿ), n being an integer variable having unique value corresponding to each of the plurality of pre-computed angles.

4. The method of claim 1, wherein iteratively scaling, manipulating, and updating comprises:
shifting the in-phase and quadrature complex samples and the corresponding phase estimate; and
adding the in-phase and quadrature complex samples and the corresponding phase estimate.

5. The method of claim 4, wherein shift operations use barrel shifters.

6. The method of claim 1, wherein providing a corresponding phase offset estimate comprises updating, for each sample, the phase offset estimate.

7. The method of claim 6, wherein updating the phase offset estimate comprises:
determining for the compensated sample value, an associated compensated sample angle;
determining for the compensated sample value, an expected symbol value having an associated expected symbol angle;
determining a difference angle between the compensated sample angle and the expected symbol angle; and
updating the phase offset estimate using the determined difference angle.

8. The method of claim 7, wherein determining the compensated sample angle comprises:
providing a compensated sample angle estimate; and
iteratively scaling, manipulating, updating the compensated sample value and the compensated sample angle estimate to converge to a compensated sample angle.

9. The method of claim 8, wherein iteratively scaling, manipulating, and updating uses a plurality of pre-computed angles.

10. The method of claim 9, wherein the plurality of pre-computed angles φₙ, are defined by φₙ=arctangent (½ⁿ), n being a integer variable having unique value corresponding to each of the plurality of pre-computed angles.

11. The method of claim 8, wherein iteratively scaling, manipulating, and updating comprises:
shifting the compensated sample value and the compensated sample angle estimate; and
adding the compensated sample value and the compensated sample angle estimate.

12. The method of claim 11, wherein shift operations use barrel shifters.

13. The method of claim 7, wherein determining the expected symbol value having an associated expected symbol angle uses a look-up table.

14. The method of claim 7, wherein updating the phase offset estimate comprises combining the determined difference angle with the phase offset estimate.

15. The method of claim 7, further comprising filtering the determined difference angle.

16. The method of claim 15, wherein filtering comprises adjusting a gain of the determined difference angle.

17. The method of claim 7, further comprising initially converting the compensated sample value to a corresponding compensated sample value residing in a first quadrant.

18. The method of claim 17, wherein converting comprises manipulating the sign of each of the respective in-phase and quadrature compensated sample value.

19. An apparatus for phase processing in-phase and quadrature signals comprising:
a receiver configured to receive successive digital in-phase and quadrature complex samples;
a phase offset register storing a corresponding estimate of the phase offset for each of the successive digital in-phase and quadrature complex samples;
phase compensating circuitry in electrical communication with the receiver and the phase offset register, the phase compensating circuitry compensating each sample for phase drift by iteratively scaling, manipulating, updating the in-phase and quadrature complex samples and the corresponding phase estimate to converge to a compensated sample value.

20. The apparatus of claim 19, wherein the phase compensating circuitry comprises:
a first register temporarily storing an in-phase component of each of the digital complex samples;
a second register temporarily storing a corresponding quadrature component of each of the digital complex samples;
a first adder receiving an input from each of the first and second registers and providing an output to the first register;
a second adder receiving an input from each of the first and second registers and providing an output to the second register;
a third register temporarily storing the corresponding phase estimate;
a memory unit storing a plurality of pre-computed angles; and
a third adder receiving an input from each of the third register and the memory unit and providing an output to the third register, each of the adders capable of selectively adding and subtracting its respective input values, the phase compensating circuitry iteratively scaling, manipulating, and updating each sample using the stored plurality of pre-computed angles.

21. The apparatus of claim 20, wherein the plurality of pre-computed angles φₙ, are defined by φₙ=arctangent (½ⁿ), n being a integer variable having unique value corresponding to each of the plurality of pre-computed angles.

22. The apparatus of claim 20, further comprising:
a first arithmetic shifter providing a shifted version of the stored in-phase component, the first arithmetic shifter coupled between the first register and the second adder; and
a second arithmetic shifter providing a shifted version of the stored quadrature component, the second arithmetic shifter coupled between the second register and the first adder.

23. The apparatus of claim 19, further comprising phase offset circuitry in electrical communication with the phase compensating circuitry and the phase offset register, the phase offset circuitry updating, for each sample, the phase offset estimate.

24. The apparatus of claim 23, wherein updating the phase offset circuitry comprises:
a first register temporarily storing in-phase component of each of the compensated samples;
a second register temporarily storing quadrature component of each of the compensated samples;
a first adder receiving an input from each of the first and second registers and providing an output to the first register;
a second adder receiving an input from each of the first and second registers and providing an output to the second register;
a third register temporarily storing the corresponding phase estimate;
a memory unit storing a plurality of pre-computed angles; and
a third adder receiving an input from each of the third register and the memory unit and providing an output to the third register, each of the adders capable of selectively adding and subtracting its respective input values, the phase offset circuitry iteratively scaling, manipulating, and updating each sample using the stored plurality of pre-computed angles to determine an angle associated with the compensated sample.

25. The apparatus of claim 24, wherein the plurality of pre-computed angles φₙ, are defined by φₙ=arctangent (½ⁿ), n being an integer variable having unique value corresponding to each of the plurality of pre-computed angles.

26. The apparatus of claim 24, further comprising:
a first arithmetic shifter coupled between the first register and the second adder, the first arithmetic shifter providing a shifted version of the stored in-phase component; and
a second arithmetic shifter coupled between the second register and the first adder, the second arithmetic shifter providing a shifted version of the stored quadrature component.

27. The method of claim 23, further comprising:
a slicer determining an expected symbol value for the compensated sample, the expected symbol value having an associated angle; and
a first adder coupled to the slicer and to the phase offset circuitry, the adder configured to determine the difference between the angle associated with the expected symbol value and the angle associated with the compensated sample.

28. The apparatus of claim 27, further comprising a second adder coupled to the phase offset register and to the output of the first adder, the output of the second adder also coupled to the phase offset register for determining and storing an accumulating phase offset value.

29. The apparatus of claim 28, further comprising a loop filter coupled between the first adder and the second adder.

30. The apparatus of claim 29, wherein the loop filter comprises a gain device.

31. The apparatus of claim 24, further comprising quadrant offset circuitry configured to manipulate the sign of each of the respective in-phase and quadrature component of the received sample thereby transforming it into a corresponding sample residing in a first quadrant.

32. An apparatus for phase processing in-phase and quadrature signals comprising:
means for receiving successive digital in-phase and quadrature complex samples;
means for providing a corresponding phase offset estimate for each of the successive digital in-phase and quadrature complex samples;
means for compensating for phase drift for each sample by iteratively scaling, manipulating, updating the in-phase and quadrature complex samples and the corresponding phase estimate to converge to a compensated sample value.

33. A method of phase processing in-phase and quadrature signals comprising:
receiving successive digital in-phase and quadrature complex samples;
for each sample, iteratively scaling, manipulating, and updating the in-phase and quadrature complex samples and a corresponding phase estimate to converge to a final result.

34. An apparatus for phase processing in-phase and quadrature signals comprising:
receiving successive digital in-phase and quadrature complex samples;
for each sample, iteratively scaling, manipulating, and updating the in-phase and quadrature complex samples and a corresponding phase estimate to converge to a final result.
